(19) United States
(12) Patent Application Publication
(10) Pub. No.: US 2008/0000361 A1
(43) Pub. Date: Jan. 3, 2008

(54) Attachment for gas barbeques

(76) Inventor: James C. Zwergel, Murrysville, PA (US)

Correspondence Address: SAND & SEBOLT, AEGIS TOWER, SUITE 1100, 4940 MUNSON STREET, NW, CANTON, OH, 44718-3615, US

(21) Appl. No.: 11/805,080

(22) Filed: May 22, 2007

Related U.S. Application Data
(60) Provisional application No. 60/817,035, filed on Jun. 28, 2006.

(51) Int. Cl. A47J 37/04

(52) U.S. Cl. 99/467

(57) ABSTRACT

A grill attachment for a gas barbeque that is connectable to the grill and is disposed intermediate the grill and the burners. The grill attachment comprises a tubular member that has an interior cavity into which is placed a flavor-enhancing substance such as mesquite wood or charcoal briquettes that include mesquite wood. The tubular member includes a plurality of first apertures in a lower wall. The first apertures allow flames from the burners to enter into the interior cavity and ignite the flavor-enhancing substances therein. The tubular member further includes a plurality of second apertures in an upper wall thereof. The second apertures allows smoke from the burning flavor-enhancing substance to exit the interior cavity and contact meat that is cooking on the grill. The tubular member is also provided with a plurality of third apertures in its outer ends. The third apertures allow ingress of ambient air that feeds oxygen to the burning flavor-enhancing substance. The tubular member may be single use or reusable.

### CROSS-REFERENCE TO RELATED APPLICATIONS

This is a standard utility application claiming priority from U.S. Provisional Application Ser. No. 60/817,035, filed Jun. 28, 2006, the entire specification of which is incorporated herein by reference.

### BACKGROUND OF THE INVENTION

1. Technical Field

This invention generally relates to barbeques. More particularly, the invention relates to an attachment that is connected to the grill of a gas barbeque. Specifically, the invention relates to a hollow grill attachment that is positioned adjacent the grill and burners and which includes flavor-enhancing substances in its interior that burn and release flavor-laced smoke which then contacts meat being cooked on the grill to enhance the flavor thereof.

2. Background Information

People have long enjoyed the flavor of meat that is cooked outdoors over an open flame. Initially, meat was cooked over wood fires, then charcoal was used and, now, most people favor cooking on gas barbeques. Over the years grilling has become somewhat of an art-form and people noticed that meat cooked over woods, such as mesquite, were flavored in a unique and desirable manner. The manufacturers of charcoal capitalized on this trend and manufactured speciality lines of charcoal briquettes that incorporated a certain percentage of mesquite wood. Yet other manufacturers have produced small packages of mesquite wood that can be placed amongst the charcoal briquettes when the fire is made. Enhancing the flavor of meat cooked on a gas barbeque is somewhat more difficult in that adding pieces of mesquite wood to a gas barbeque is dangerous. Consequently, the only avenue open to the cook is that of adding of spices and flavorings directly to the meat itself. The end result, however, is never quite the same as cooking the meat in the smoke of mesquite and like substances.

There is therefore a need in the art for a way to enhance the flavor of meat cooked on a gas barbeque.

### SUMMARY OF THE INVENTION

The device of the present invention comprises a metal tubular member that is positioned adjacent the grill of a barbeque so that it is positioned between the grill and the burners. The tubular member defines an interior cavity into which is placed a flavor-enhancing substance such as mesquite wood or charcoal briquettes that include mesquite wood. The tubular member includes a plurality of first apertures in a lower wall which allow flames from the burners to enter into the interior cavity and ignite the flavor-enhancing substances therein. The tubular member further includes a plurality of second apertures in an upper wall thereof. Second apertures allow smoke from the burning flavor-enhancing substance to exit the interior cavity and contact meat that is cooking on the grill. The tubular member is also provided with a plurality of third apertures in its outer ends. The third apertures allow ingress of ambient air that feeds oxygen to the burning flavor-enhancing substance. The tubular member may be a single use device or may be reusable.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a cross-sectional front view through a gas barbeque and showing the grill attachment of the present invention;

FIG. 2 is a partially cut away top view of the grill attachment;

FIG. 3 is a front view of the grill attachment;

FIG. 4 is a side view of the grill attachment;

FIG. 5 is a cross-sectional side view of the grill attachment through line 5-5 of FIG. 1 and showing the burning flavor-enhancing substance and the smoke rising therefrom;

FIG. 6 is a front view of a second embodiment of grill attachment in accordance with the present invention;

FIG. 7 is a cross-sectional side view of the grill attachment of FIG. 6 shown in an open position; and

FIG. 8 is a cross-sectional side view of the grill attachment of FIG. 6 shown in a closed position.

### DETAILED DESCRIPTION OF THE INVENTION

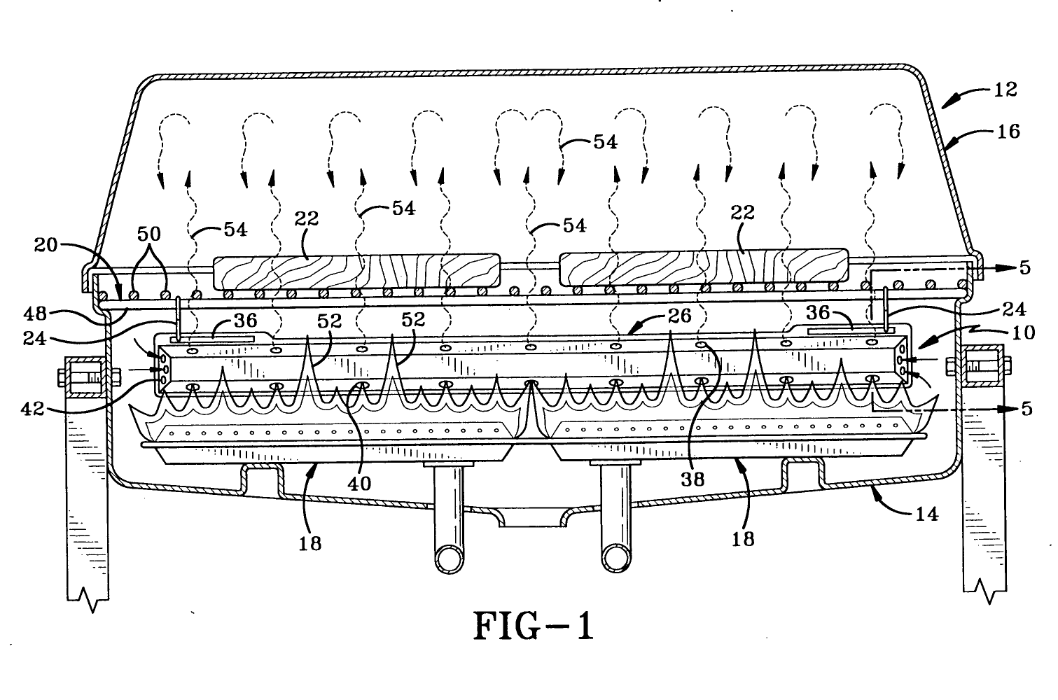

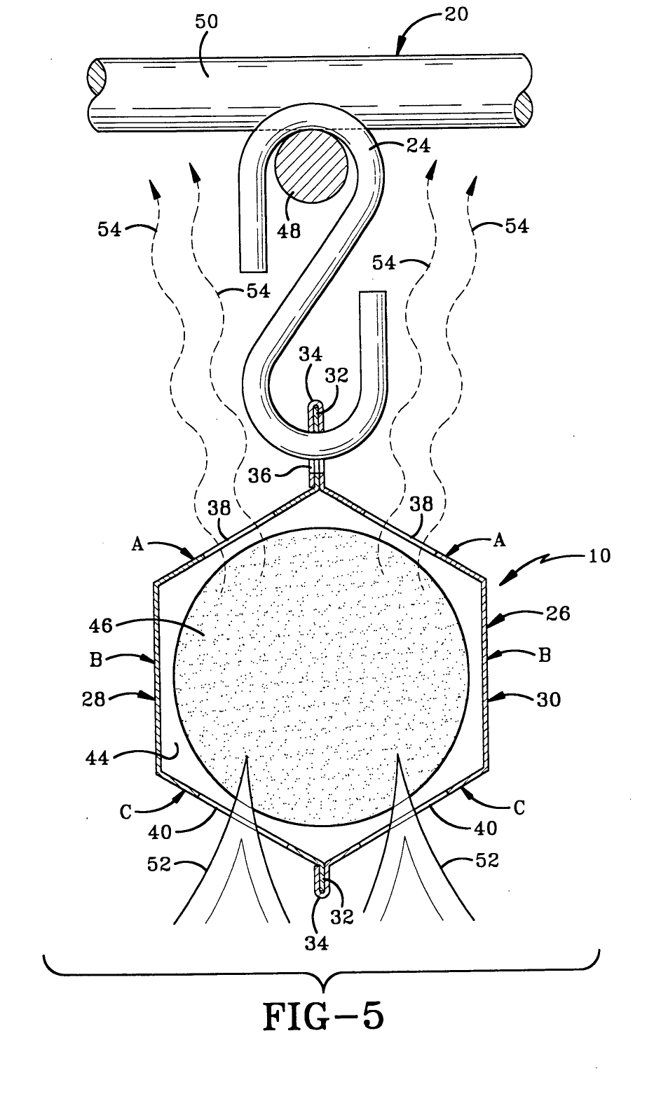

Referring to FIGS. 1-5, there is shown a grill attachment in accordance with the present invention and generally indicated at 10. Grill attachment 10 is used in a conventional gas barbeque 12 that includes a base 14, a lid 16, a plurality of burners 18 and a grill 20 upon which a plurality of pieces of meat 22 are cooked. Grill attachment 10 is positioned below grill 20 and above burners 18. Preferably, grill attachment 10 is suspended between grill 20 and burners 18 by a plurality of hangers 24, such as the S-hooks illustrated in FIG. 5.

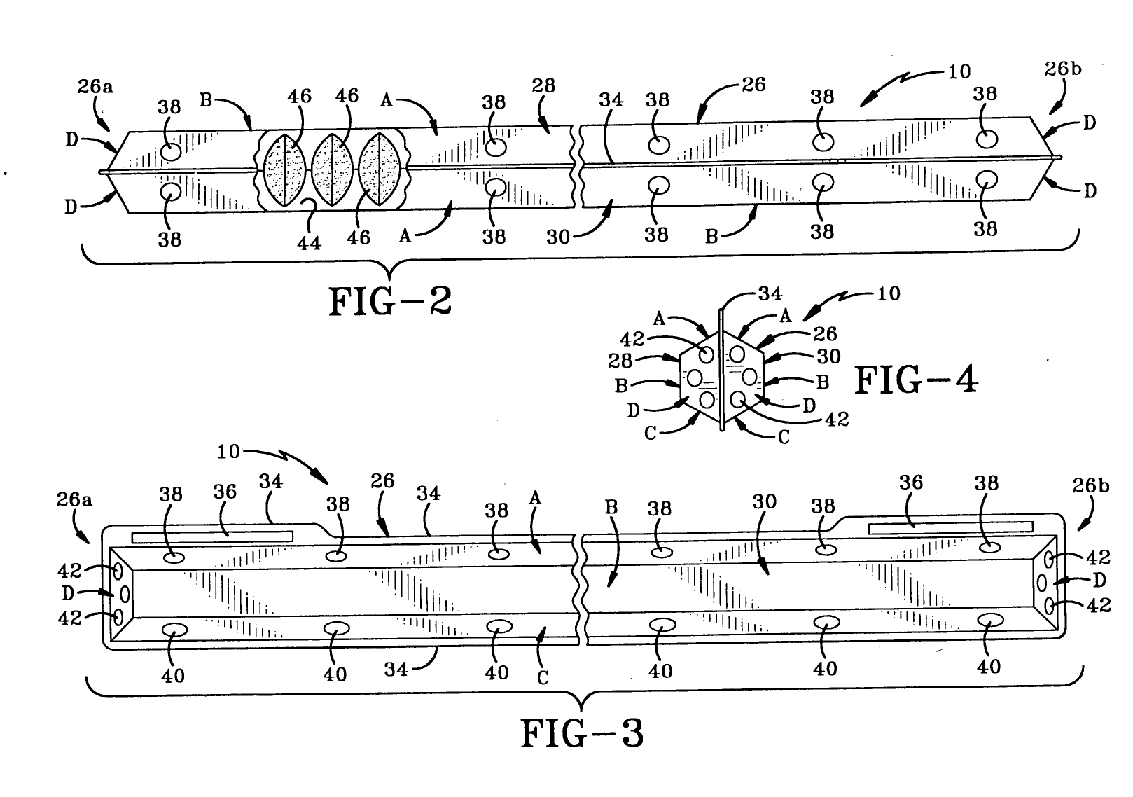

Grill attachment 10 comprises a metal tube 26 that preferably is generally hexagonal in cross-sectional shape (FIG. 4) and preferably is between ¾″ and 2″ in diameter. Tube 26 preferably is manufactured from first and second members 28, 30 that are connected together. First and second members 28 and 30 are substantially identical, each being of generally U-shaped in cross-section and terminating in a lip 32 and 34, respectively. Lips 32, 34 are joined together, preferably by crimping (FIG. 5), although rivets or welding could be used instead. Lips 32, 34 are enlarged near each of the outer ends 26a, 26b of tube 26 and are provided with slots 36 (FIG. 3) through which hangers 24 are received. Slots 36 are elongated so that hangers 24 may be placed at any position therein that would be suitable to connect tube 26 to any type of grill 20.

Because tube 26 is hexagonal in cross-section, each of first and second members 28, 30 has three faces. These are identified generally as faces “A”, “B” and “C” in FIG. 4. Because of the manner in which first and second members 28, 30 are joined together and because the tube 26 is suspended from grill 20, faces “A” constitute the upper walls of tube 26, faces “B” constitute the outermost walls thereof, and faces “C” constitute the lower walls of tube 26. Faces “A” are provided with a plurality of spaced-apart first apertures 38, faces “C” are provided with a plurality of spaced-apart second apertures 40, and faces “B” are free of apertures. This may be seen most clearly in FIG. 3. First and second members 28, 30 also include inclined end walls “D” that are provided with third apertures 42. First and second apertures 38 and 40 preferably are placed in alignment with each other along the length of tube 26. The purpose of first, second and third apertures 38, 40 and 42 will be hereinafter described.

First and second members 28, 30 define an interior cavity 44 therebetween. Flavor enhancing substances 46 are placed into the interior cavity 44 before lips 32, 34 are crimped together. Substances 46 may include pieces of mesquite wood, mesquite laced charcoal briquettes or any other substance that, when burned, may impart a desirable flavor to meat 22 retained on the grill 20.

Grill attachment 10 preferably is a single use device. Consequently, the metal used to manufacture tube 26 does not need to be particularly durable. Grill attachment 10 is used in the following manner. The hangers 24 are placed in slots 36 and are then connected to the underside of grill 20. Hangers 24 may be connected to either grill supports 48 or grill rods 50, although the former is preferable because the hangers 24 will then not interfere with the meat 22. Burners 18 are ignited and, as the flames 52 reach upwardly, some of them enter the second apertures 40 in faces “B” of tube 26. Flames 52 cause substances 46 within cavity 44 to ignite. Fresh ambient air is drawn into cavity 44 through third apertures 42 in end walls “D” thereby feeding oxygen to the burning substances 46. The burning substances 46 release flavor-laced smoke 54 which exits tube 26 through first apertures 38 in faces “A”. The smoke 54 rises upwardly and imparts flavors to meat 22 as it cooks. When the user is finished barbequing the meat 22 and the barbeque 12 has cooled down, tube 26 is removed from grill 20 by detaching hangers 24. Tube 26 is then thrown away.

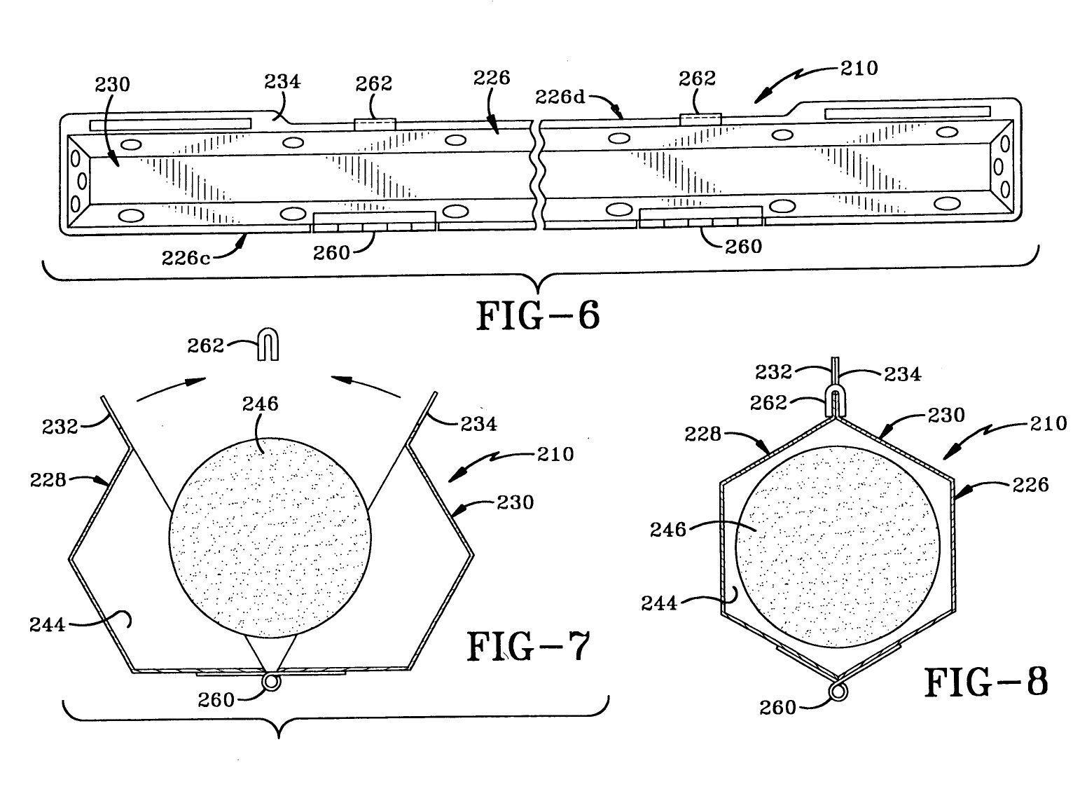

FIGS. 6-8 illustrate a second embodiment of grill attachment in accordance with the present invention and generally indicated at 210. Grill attachment 210 is substantially identical to grill attachment 10 except that tube 226 is designed to be reusable. As such, tube 226 is manufactured from a more durable metal, such as stainless steel and is provided with hinges 260 proximate the bottom end 226c. Hinges 260 permit tube 26 to be opened so that fresh supplies of flavor-enhancing substances 246 may be introduced into cavity 244. Tube 26 may also be opened to remove any debris (not shown) remaining within cavity 244 after substances 246 have burned down. Clips 262 are provided to keep lips 232 and 234 of first and second members 228, 230 in abutting contact when tube 226 is to be attached to a grill. Grill attachment 210 is used in substantially the same manner as grill attachment 10 except that it is not thrown away after use, but is instead refilled with flavor enhancing substances 246.

While tube 26 has been disclosed as generally hexagonal in shape, it will be understood that tube 26 may be of any other suitable cross-sectional shape, such as circular or square, without departing from the spirit of the present invention.

It will also be understood that tube 226 may be opened in any other suitable manner, such as by providing a hinged door (not shown) at either of the end walls thereof through which substances 246 may be introduced into cavity 244.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An attachment for a grill for a barbeque, said attachment comprising:
an elongated tubular member adapted to be positioned adjacent the grill of the gas barbeque;
an interior cavity defined within the tubular member and being adapted to receive a flavor enhancing substance therein;
a plurality of first apertures formed in a lower wall of the tubular member and adapted to receive flames from the gas barbeque therein;
a plurality of second apertures formed in an upper wall of the tubular member; said second apertures being adapted to allow smoke from the substances within the cavity to escape out of the tubular member.

2. The grill attachment as defined in claim 1, wherein the elongated tubular member further includes opposed end walls that extend between the upper and lower walls; and wherein each end wall includes a plurality of third apertures therein.

3. The grill attachment as defined in claim 1, wherein the tubular member is comprised of substantially identical first and second members that are joined together along their outer edges, wherein said first and second members define the interior cavity of the tubular member thereinbetween; and wherein the upper wall of the tubular member is formed partially from a portion of each of the first and second members; and the lower wall of the tubular member is formed partially from a portion of each of the first and second members.

4. The grill attachment as defined in claim 3, wherein the tubular member is substantially hexagonal in cross-section.

5. The grill attachment as defined in claim 4, wherein each of the first and second members is substantially U-shaped and each includes a first face, a second face and a third face.

6. The grill attachment as defined in claim 5, wherein the first apertures are formed in the first face of each of the first and second members;
and the second apertures are formed in the third face of each of the first and second members.

7. The grill attachment as defined in claim 1, wherein each of the first apertures is aligned with one of the second apertures.

8. The grill attachment as defined in claim 5, wherein the second faces of each of the first and second members are free of apertures.

9. The grill attachment as defined in claim 3, wherein the outer edges of each of the first and second members includes a lip, and the lips of the first and second members are crimped together.

10. The grill attachment as defined in claim 9, wherein a portion of the lips of the first and second members along an uppermost edge thereof is provided with a slot that is adapted to receive a hanger for suspending the tubular member from the grill.

11. The grill attachment as defined in claim 1, wherein the tubular member is manufactured as a sealed unit and is disposable.

12. The grill attachment as defined in claim 3, further comprising:
at least one hinge that joins the first and second members together along a first edge of the tubular member; and
at least one clip that releasably secures the first and second members together along a second edge of the tubular member.

13. The grill attachment as defined in claim 12, wherein the first and second members are manufactured from stainless steel and the attachment is reusable.

14. A flavor-enhancing grill attachment for connection to a grill of a barbeque, said grill attachment comprising:
an elongated tubular member defining an interior cavity therein; said tubular member having a plurality of first apertures formed in a lower wall thereof and a plurality of second apertures formed in an upper wall thereof;
a flavor-enhancing substance retained within the interior cavity of the tubular member; and
a connector mechanism for attaching the tubular member to the grill of the barbeque.

15. The grill attachment as defined in claim 14, wherein the tubular member comprises a first member and a second side that are joined together to define the interior cavity therebetween.

16. The grill attachment as defined in claim 14, wherein the first and second members are permanently connected together and the tubular member is disposable after a single use.

17. The grill attachment as defined in claim 16, further comprising:
at least one hinge mounted to an edge of each of the first and second members to connect the first and second members together; whereby the tubular member is openable to allow access into the interior cavity thereof; and
at least one clip releasably connectable to a second edge of each the first and second members to secure said second edges together.

18. The grill attachment as defined in claim 14, wherein the tubular member includes opposing outer ends, and wherein each outer end includes a plurality of third apertures that are adapted to allow ambient air to flow into the interior cavity of the tubular member.

19. The grill attachment as defined in claim 14, wherein the flavor-enhancing substances are selected from the group comprising mesquite wood and charcoal briquettes that include mesquite wood therein.
